(19) United States
(12) Patent Application Publication
(10) Pub. No.: US 2012/0095807 A1
(43) Pub. Date: Apr. 19, 2012

(54) METHODS AND APPARATUS FOR OPERATING AN ELECTRONIC BILLING REPOSITORY

(76) Inventor: John A. Kowalonek, Clinton, MA (US)

(21) Appl. No.: 12/233,094

(22) Filed: Sep. 18, 2008

Related U.S. Application Data
(60) Provisional application No. 60/973,303, filed on Sep. 18, 2007.

(51) Int. Cl. G06Q 20/22; G06Q 30/00

(52) U.S. Cl. 705/7.36; 705/40; 705/34

(57) ABSTRACT

A system allows at least one customer to register with the billing repository. The billing repository operating process provides the customer with a unique identifier that identifies the customer within the billing repository. The billing repository operating process allows a plurality of billers to register with the billing repository. At least one of the plurality of billers provides billing to the customer. The billing repository operating process associates, in the billing repository, the customer with a subset of billers from the plurality of billers, using the unique identifier. The subset of billers identifies the customer by the unique identifier. The billing repository operating process allows the customer and the subset of billers to electronically transact a plurality of bills aided by the billing repository.

### CROSS REFERENCE TO RELATED APPLICATIONS

The present application claims the benefit of U.S. Provisional Patent Application No. 60/973,303, filed on Sep. 18, 2007, which is incorporated herein by reference in its entirety.

### BACKGROUND

Over sixty percent of Americans will pay some of their bills online this year, however, most Americans will not pay all of their bills online. In 2005, sixty-five percent of customers paid their bills using paper checks. Most customers, who already pay some of their bills electronically, would be willing to forgo receiving paper-based bills, if offered the choice. Yet, the practice of paying bills electronically is growing slowly, only at an annual rate of slightly more than three percent per year. While many large companies already offer electronic billing to their customers, many small companies do not have the ability to offer such services.

Typically, when switching from paper-based billing to electronic billing, a customer performs a separate registration process for each bill provider. The registration process may consist of the customer entering detailed account information to initiate the electronic billing process, and then subscribing to a service that notifies the customer when the bill is ready. The customer may also have to notify the bill provider that the customer no longer wishes to receive a paper-based bill. The customer performs these steps for each bill provider. The customer may perform these steps through their online banking web site, or at the web site of the bill provider.

### SUMMARY

Conventional computerized technologies for providing electronic billing suffer from a variety of deficiencies. In particular, conventional technologies providing electronic billing are limited in that not every biller has the ability to provide electronic billing, and therefore, the customer is not able to pay each of their bills electronically. Small billers (i.e., companies that do not have a large customer base), and occasional billers (i.e., companies, such as electricians, plumbers, etc., who bill customers when the work is performed, but do not generally bill on a month to month basis) often cannot justify the cost of instituting electronic billing for their customers. Often, there are a minimum number of customers a biller must bill on a monthly basis to justify the cost, and small or occasional billers cannot meet this minimum.

Conventional technologies also place the burden of switching from paper-based billing to electronic billing on the customer. The customer must register separately for electronic billing with each biller. This entails entering detailed customer information (i.e., name, postal address, account number, social security number, etc.) to initiate the electronic billing process, and then subscribing to a service that notifies the customer when the bill is ready. The customer may also have to notify the bill provider that the customer no longer wishes to receive a paper-based bill. The customer may perform these steps through their online banking web site, or at the web site of the bill provider, each of which requires the customer to possess (and remember) a login and password for each web site. Even after all this effort, the customer is still forced to pay some of their bills using paper-based billing since not all bill providers are capable of providing electronic billing.

Additionally, the business practices are inconsistent. When viewing bills electronically, the customer will find that some of their bills are available for viewing immediately, while other bills are available only when those bills are due. Other bills require a verification process that may take days. Some billers allow the customer to pay by credit card or bank account, while other billers allow only bank payments, or only credit card payment. In addition, a few smaller billers support only Paypal, requiring the customer to also set up a Paypal account.

Embodiments disclosed herein significantly overcome such deficiencies and provide a system that includes a computer system and/or software executing a billing repository operating process that allows a customer to register with a billing repository to pay all of the customer's bills electronically. The billing repository operating process provides the customer with a unique identifier (i.e., not a social security number, or some other previously used unique identifier) with which to identify the customer within the billing repository. The billing repository operating process allows billers to register with the billing repository to allow the billers to provide electronic billing to their customers. The billing repository operating process associates, within the billing repository, the customers with their respective billers.

During the registration of a customer, the billing repository operating process associates the unique identifier with key information associated with the customer, such as the customer's name and postal address (normalized), their government issued identification (i.e., Social Security Number), etc. The billing repository operating process allows billers to use the customer's name, postal address (normalized), and/or their government issued identification to locate the unique identifier. Billers may user the unique identifier to associate the customer bills in the billing repository with the customer, and deliver the bill to the customer. Using conventional technologies, the customer must register individually to receive each bill. The billing repository operating process utilizes a postal address to identify customers to which billers may send electronic bills.

Billers (who are registered with the billing repository) may deliver electronically any bill that would otherwise be mailed to a (registered) customer's postal address. This is true regardless whether the bills are “periodic” (i.e. monthly) bills, or a “one time” or “occasional” bill. Small billers, utilizing the billing repository, would not be required to create an elaborate mechanism allowing their customers to register for electronic billing. Also, small billers would not have to pay fees to access a consolidation network.

The billing repository operating process provides a change of address notification when a customer moves. The customer may enter their new address once into the billing repository or initiate a postal address change by using commercially available postal address change software. This capability allows the billing repository operating process to reduce the number of “lost bills” that occur when people move. This capability will also allow utility companies to determine if a customer has moved without notifying the utility company.

The billing repository operating process provides consolidators the benefit of easier electronic billing. For example, the customer may indicate, via the consolidator, that the customer would prefer to receive all their bills electronically. The billing repository operating process also allows small billers to connect to consolidators. Typically, consolidators may transmit a paper check to a small biller (even when a customer pays that bill online). The billing repository operating process, instead, transmits the funds electronically because the small biller has access to the consolidator.

In an example embodiment, the billing repository operating process may also be utilized to transmit paper-based mail (such as advertisements) electronically. In this scenario, the billing repository operating process would operate as a clearinghouse for mail, and deliver, for example, all advertisements, electronically, thus reducing the amount of paper waste generated each year. The billing repository operating process delivers any mail (that would have been sent to a physical postal address) electronically. This mail may be delivered electronically as long as:

i) the information in the mail may be transmitted in electronic form,

ii) the customer has registered with the billing repository, and

iii) the biller has the correct name and postal address.

In an example embodiment, the billing repository operating process provides a customer (or prospective customer) with a list of billers who are registered with the billing repository to encourage the customer to utilize the billing repository operating process for paying all the customer's bills. Once the customer has registered with the billing repository, the customer has access to pay their bills with all the currently registered billers. As other billers register with the billing repository at a later date, the customer will have access to pay bills electronically with those billers, without additional registration steps on the part of the customer. Likewise, once a biller has registered with the billing repository, that biller can transact bills to any current customer who is also registered within the billing repository. The biller will also be able to transact bills with customers who register with the billing repository at a later date, without the biller having to re-register with the billing repository. The biller may even transact bills with customers not yet registered with the billing repository. In this scenario, the billing repository operating process transmits a paper-based bill to the customer, along with an invitation to register with the billing repository.

In an example embodiment, once the biller has registered with the billing repository, the biller may provide the billing repository with information associated with a customer (i.e., name, address, etc.). The billing repository operating process performs a lookup search on the billing repository to determine whether the customer is registered with the billing repository. The billing repository operating process then reports the result of the search to the biller. If the customer is registered the biller may begin to transact bills with the customer. If the customer is not registered with the billing repository, the billing repository operating process transmits a paper-based bill to the customer. As mentioned above, an invitation is also sent to the customer, inviting the customer to register with the billing repository to be able to transact bills with the biller (and any of the customer's other billers.)

In an example embodiment, the billing repository operating process provides the billers with a choice of whether to transmit a paper-based bill or an electronic bill to the customer. The billing repository operating process may provide the customer with a paper-based bill, even after the customer has registered for electronic billing. The paper-based bill may be provided for a short period of time (such as three months), at which time the billing repository operating process stops transmitting a paper bill to the customer, and the customer relies on electronic billing from that time forward. In another example embodiment, the billing repository operating process can switch from electronic billing back to paper-based billing should the customer require that switch. The customers and the billers may transact the bills at the billing repository operating process, or even at a consolidator, such as a banking web site. The billing repository operating process may also provide an incentive to the customer to utilize the billing repository. For example, the billing repository operating process may give a discount to the customer when the customer registers for the billing repository, or provide the customer with some type of premium (such as a gift card, etc.) It should also be noted that the customer also saves the cost of postage stamps and printed checks by transacting bills electronically.

In an example embodiment, the billing repository operating process provides a measure of security against identity theft by providing notification if more than one unique identifier (associated with a customer) is tied to the same social security number. For example, the billing repository operating process may discover identity theft by determining that multiple customers are using the same social security number. Customers provide billers with customer information such as social security numbers. A biller might compare social security numbers maintained within the billing repository with social security numbers associated with that biller's customers (meaning both customers who are registered with the billing repository, and those customers who are not registered with the billing repository). That comparison may identify duplicate social security numbers, even if one of the customers identified was not a registered user of the billing repository.

In an example embodiment, the billing repository operating process collects a payment from each of the billers using the billing repository operating process. Each biller pays a fee for each customer with which that biller transacts bills. Typically, medium and large sized billers can afford the costs, but small billers might not. Therefore, in another example embodiment, the billing repository operating process provides use of the billing repository operating process to small billers for free such that customers may transact all of their bills through the billing repository. These small billers might not have the infrastructure that allows them to connect with the billing repository. In an example embodiment, the billing repository operating process provides these small billers with an interface that allows the small billers to access the billing repository using whatever existing infrastructure the small billers currently use to bill their customers.

Embodiments disclosed herein also include a computer system executing a billing repository operating process that allows at least one customer to register with the billing repository. The billing repository operating process provides the customer with a unique identifier that identifies the customer within the billing repository. The billing repository operating process allows a plurality of billers to register with the billing repository. At least one of the plurality of billers provides billing to the customer. The billing repository operating process associates, in the billing repository, the customer with a subset of billers from the plurality of billers, using the unique identifier. The subset of billers identifies the customer by the unique identifier. The billing repository operating process allows the customer and the subset of billers to electronically transact a plurality of bills aided by the billing repository.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in data communications devices and other computerized devices and software systems for such devices such as those manufactured by Sorriso Technologies, Inc. of Acton, Mass.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a high-level block diagram of a system according to one embodiment disclosed herein.

FIG. 2 shows a high-level block diagram of a computer system according to one embodiment disclosed herein.

FIG. 3 illustrates a flowchart of a procedure performed by the system of FIG. 1, when the billing repository operating process allows at least one customer to register with the billing repository, according to one embodiment disclosed herein.

FIG. 4 illustrates a flowchart of a procedure performed by the system of FIG. 1, when the billing repository operating process allows at least one customer to register with the billing repository, and receives notification that the customer has provided a postal address, according to one embodiment disclosed herein.

FIG. 5 illustrates a flowchart of a procedure performed by the system of FIG. 1, when the billing repository operating process allows at least one customer to register with the billing repository, and provides, to the customer, information associated with a plurality of registered billers, according to one embodiment disclosed herein.

FIG. 6 illustrates a flowchart of a procedure performed by the system of FIG. 1, when the billing repository operating process allows a plurality of billers to register with the billing repository, at least one of the plurality of billers providing billing to at least one customer, according to one embodiment disclosed herein.

FIG. 7 illustrates a flowchart of a procedure performed by the system of FIG. 1, when the billing repository operating process allows the customer and the subset of billers to electronically transact a plurality of bills, aided by the billing repository, according to one embodiment disclosed herein.

FIG. 8 illustrates a flowchart of a procedure performed by the system of FIG. 1, when the billing repository operating process allows the customer and the subset of billers to electronically transact a plurality of bills aided by the billing repository, at the billing repository, according to one embodiment disclosed herein.

FIG. 9 illustrates a flowchart of a procedure performed by the system of FIG. 1, when the billing repository operating process allows the customer and the subset of billers to electronically transact a plurality of bills, and receives notification that at least one of the subset of billers has identified that another unique identifier is associated with a plurality of customers, according to one embodiment disclosed herein.

FIG. 10 illustrates a flowchart of a procedure performed by the system of FIG. 1, when the billing repository operating process allows the customer and the subset of billers to electronically transact a plurality of bills, and provides an interface for the plurality of billers to access the billing repository, according to one embodiment disclosed herein.

### DETAILED DESCRIPTION

Embodiments disclosed herein include a computer system executing a billing repository operating process that allows at least one customer to register with the billing repository. The billing repository operating process provides the customer with a unique identifier that identifies the customer within the billing repository. The billing repository operating process allows a plurality of billers to register with the billing repository. At least one of the plurality of billers provides billing to the customer. The billing repository operating process associates, in the billing repository, the customer with a subset of billers from the plurality of billers, using the unique identifier. The subset of billers identifies the customer by the unique identifier. The billing repository operating process allows the customer and the subset of billers to electronically transact a plurality of bills aided by the billing repository.

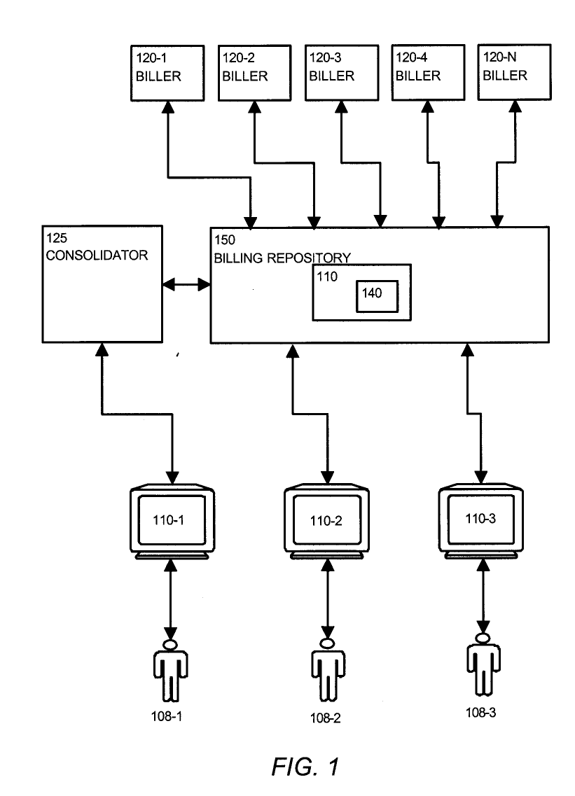

FIG. 1 is an example a high-level block diagram of a system according to one embodiment disclosed herein. The billing repository 150 runs on a computerized device 110 on which the billing repository operating process 140-2 is also operating. A plurality of billers 120-N communicates with the billing repository 150, sending bills to customers 108-N, and, in return, receiving payments from customers 108-N. The customers 108-N communicate with billing repository 150 via either the billing repository 150, or a consolidator 125 (acting as an interface between the customers 108-N, and the billing repository 150). The customers 108-N access the billing repository 150 using their own computers (i.e., computerized device 110).

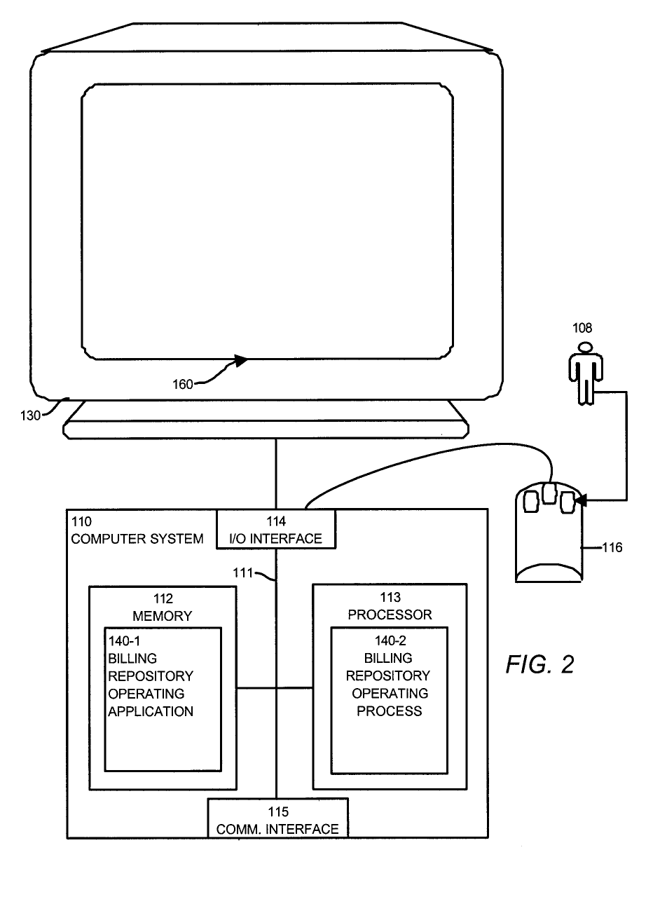

FIG. 2 is a block diagram illustrating example architecture of a computer system 110 that executes, runs, interprets, operates or otherwise performs a billing repository operating application 140-1 and billing repository operating process 140-2 suitable for use in explaining example configurations disclosed herein. The computer system 110 may be any type of computerized device such as a personal computer, workstation, portable computing device, console, laptop, network terminal or the like. An input device 116 (e.g., one or more customer/developer controlled devices such as a keyboard, mouse, etc.) couples to processor 113 through I/O interface 114, and enables a customer 108 to provide input commands, and generally control the graphical customer interface 160 that the billing repository operating application 140-1 and process 140-2 provides on the display 130. Essentially, the graphical user interface 160 is where the customer 108-1 performs their ‘online banking’, specifying which bills are to be paid electronically, when those bills are to be paid, and the amount to be paid. As shown in this example, the computer system 110 includes an interconnection mechanism 111 such as a data bus or other circuitry that couples a memory system 112, a processor 113, an input/output interface 114, and a communications interface 115. The communications interface 115 enables the computer system 110 to communicate with other devices (i.e., other computers) on a network (not shown).

The memory system 112 is any type of computer readable medium, and in this example, is encoded with a billing repository operating application 140-1 as explained herein. The billing repository operating application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of a billing repository operating application 140-1. Execution of a billing repository operating application 140-1 in this manner produces processing functionality in the billing repository operating process 140-2. In other words, the billing repository operating process 140-2 represents one or more portions or runtime instances of a billing repository operating application 140-1 (or the entire a billing repository operating application 140-1) performing or executing within or upon the processor 113 in the computerized device 110 at runtime.

It is noted that example configurations disclosed herein include the billing repository operating application 140-1 itself (i.e., in the form of un-executed or non-performing logic instructions and/or data). The billing repository operating application 140-1 may be stored on a computer readable medium (such as a floppy disk), hard disk, electronic, magnetic, optical, or other computer readable medium. A billing repository operating application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of a billing repository operating application 140-1 in the processor 113 as the billing repository operating process 140-2. Those skilled in the art will understand that the computer system 110 may include other processes and/or software and hardware components, such as an operating system not shown in this example.

A display 130 need not be coupled directly to computer system 110. For example, the billing repository operating application 140-1 can be executed on a remotely accessible computerized device via the network interface 115. In this instance, the graphical customer interface 160 may be displayed locally to a customer 108 of the remote computer, and execution of the processing herein may be client-server based.

Further details of configurations explained herein will now be provided with respect to a flow chart of processing steps that show the high level operations disclosed herein to perform the billing repository operating process 140-2.

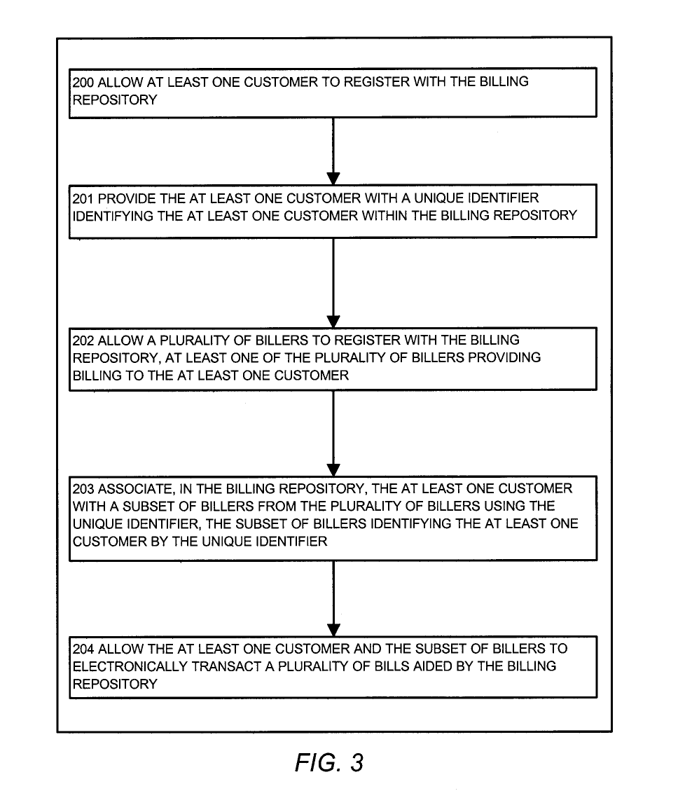

FIG. 3 is an embodiment of the steps performed by billing repository operating process 140-2 when it allows at least one customer 108-1 to register with the billing repository 150.

In step 200, the billing repository operating process 140-2 allows at least one customer 108-1 to register with the billing repository 150. The customer 108-1 registers with the billing repository 150 once to electronically transact with all the customer's 108-1 billers 120-N, including future billers 120-N who may register with the billing repository 150 at a later date. The billing repository 150 is analogous to the customer's 108-1 postal mailbox, where, once the customer 108-1 identifies a postal address as the location at which the customer 108-1 may receive their bills, the customer 108-1 only has to look in one place (i.e., their postal mailbox) to retrieve their bills. When a customer 108-1 registers with the billing repository 150, the customer 108-1 indicates that they would like to receive all their bills via the billing repository 150.

In step 201, the billing repository operating process 140-2 provides a customer 108-1 with a unique identifier that identifies the customer 108-1 within the billing repository 150. When the customer 108-1 registers with the billing repository 150, the billing repository operating process 140-2 provides the customer 108-1 with a unique identifier that is linked to the customer's 108-1 postal address. In an example embodiment, during the registration process, the customer 108-1 agrees to receive all their bills via the biller 120-1. In another example embodiment, the customer 108-1 may register with the billing repository 150 via a consolidator 125, or even at the web site of a biller 120-1. In another example embodiment, the customer 108-1 may choose to pay their billers 120-N with paper check. In this scenario, the customer 108-1 pays the biller's 120-1 bill electronically, and the billing repository operating process 140-2 issues a paper-based check to the biller 120-1.

In step 202, the billing repository operating process 140-2 allows a plurality of billers 120-N to register with the billing repository 150. At least one of the plurality of billers 120-N provides billing to at least one customer 108-1. Billers 120-N register with the billing repository 150 to provide the billers' 120-N customers 108-N with the opportunity to receive bills electronically. Transmitting bills electronically allows the billers 120-N to save the costs of sending out paper-based bills.

In step 203, the billing repository operating process 140-2 associates, in the billing repository 150, at least one customer 108-1 with a subset of billers 120-N from the plurality of billers 120-N using the unique identifier. In other words, the billing repository operating process 140-2 associates the customer 108-1 with their respective bills.

In step 204, the billing repository operating process 140-2 allows at least one customer 108-1 and the subset of billers 120-N to electronically transact a plurality of bills, aided by the billing repository 150. The billing repository operating process 140-2 allows the customer 108-1 to transact (i.e., receive and pay) their bills, via the billing repository 150.

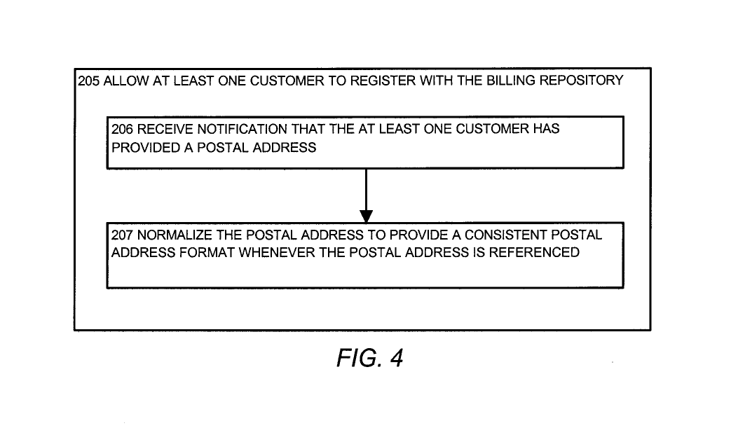

FIG. 4 is an embodiment of the steps performed by billing repository operating process 140-2 when it allows at least one customer 108-1 to register with the billing repository 150.

In step 205, the billing repository operating process 140-2 allows at least one customer 108-1 to register with the billing repository 150. In an example embodiment, the customer 108-1 may register with the billing repository 150 to receive (and pay) their bills electronically.

In step 206, the billing repository operating process 140-2 receives notification that the customer 108-1 has provided a postal address. The customer 108-1 provides a postal address during the registration process. In an example embodiment, if a customer 108-1 changes their postal address through the U.S. Postal Service, a biller 120-1, consolidator 125, or the billing repository 150 logs the change in postal address. The billing repository operating process 140-2 provides the customer 108-1 with a process to confirm the change in postal address, using a PIN that allows the customer 108-1 to validate the new postal address.

In step 207, the billing repository operating process 140-2 normalizes the postal address to provide a consistent postal address format whenever the postal address is referenced. When a customer 108-1 enters a postal address, the billing repository operating process 140-2 runs the postal address through a cleansing process to normalize the postal address.

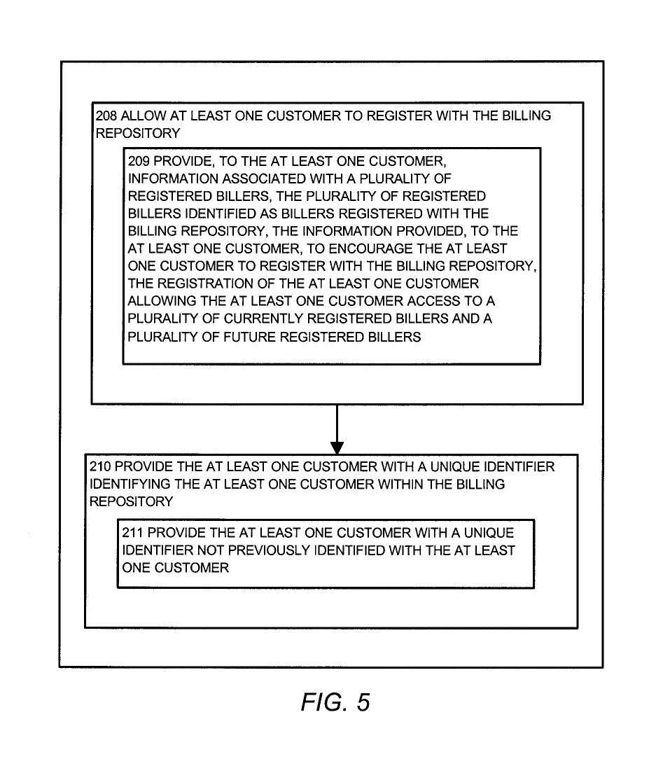

FIG. 5 is an embodiment of the steps performed by billing repository operating process 140-2 when it allows at least one customer 108-1 to register with the billing repository 150.

In step 208, the billing repository operating process 140-2 allows at least one customer 108-1 to register with the billing repository 150. In an example embodiment, when the customer 108-1 registers with the billing repository 150, the customer 108-1 is provided with a list of billers 120-N with whom the customer 108-1 may transact bills.

In step 209, the billing repository operating process 140-2 provides, to the customer 108-1, information associated with a plurality of registered billers 120-N. The plurality of registered billers 120-N is identified as billers 120-N registered with the billing repository 150. This information is provided to the customer 108-1 to encourage the customer 108-1 to register with the billing repository 150. When the customer 108-1 registers with the billing repository 150, the billing repository operating process 140-2 allows the customer 108-1 to access to a plurality of currently registered billers 120-N (as well as a plurality of future registered billers 120-N). In other words, the customer 108-1 registers with the billing repository 150 once, and has access to transact bills with currently registered billers 120-N, and will have access to billers 120-N who register in the future, without the customer 108-1 having to register again.

In step 210, the billing repository operating process 140-2 provides at least one customer 108-1 with a unique identifier, identifying the customer 108-1 within the billing repository 150. Once the customer 108-1 registers, the customer 108-1 is provided with a unique identifier that identifies the customer 108-1 within the billing repository 150.

In step 211, the billing repository operating process 140-2 provides the customer 108-1 with a unique identifier not previously identified with the customer 108-1. In an example embodiment, the billing repository operating process 140-2 provides the customer 108-1 with a unique identifier not previously identified with the customer 108-1 (such as a social security number, billing account number, etc.).

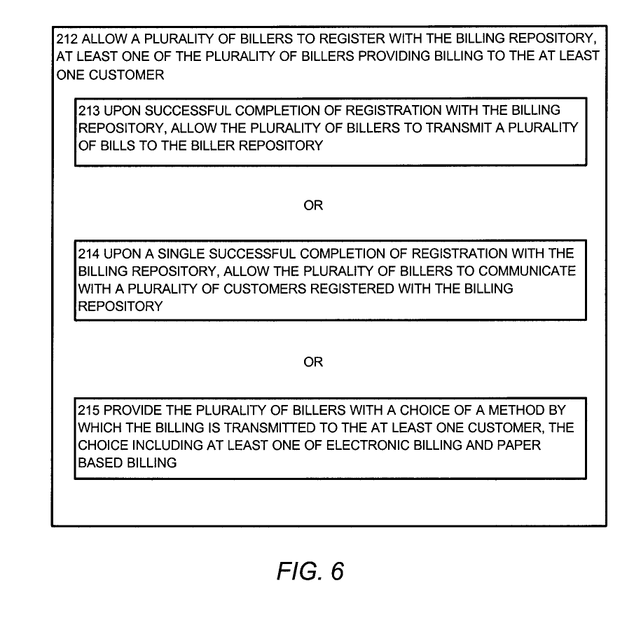

FIG. 6 is an embodiment of the steps performed by billing repository operating process 140-2 when it allows a plurality of billers 120-N to register with the billing repository 150.

In step 212, the billing repository operating process 140-2 allows a plurality of billers 120-N to register with the billing repository 150 wherein at least one of the plurality of billers 120-N provides billing to the customer 108-1. The billing repository operating process 140-2 allows billers 120-N to register with the billing repository 150 so that the billers 120-N may send bills to their respective customers 108-N and received payments in return.

In step 213, upon successful completion of registration with the billing repository 150, the billing repository operating process 140-2 allows the plurality of billers 120-N to transmit a plurality of bills to the billing repository 150. Once registered, the plurality of billers 120-N may transmit bills to the billing repository 150 that, in turn, are transmitted to customers 108-N.

Alternatively, in step 214, upon a single successful completion of registration with the billing repository 150, the billing repository operating process 140-2 allows the plurality of billers 120-N to communicate with a plurality of customers 108-N registered with the billing repository 150. In other words, the plurality of billers 120-N need only register with the billing repository 150 once to have access to all currently registered customers 108-N. As new customers 108-N register with the billing repository 150 in the future, the plurality of billers 120-N will have access to those new customers 108-N without the plurality of billers 120-N having to re-register.

Alternatively, in step 215, the billing repository operating process 140-2 provides the plurality of billers 120-N with a choice of a method by which the billing is transmitted to the customer 108-1. The choice includes at least one of electronic billing and paper-based billing. The plurality of billers 120-N has the choice to transmit bills to customers 108-N either via electronic billing, paper-based billing, or both.

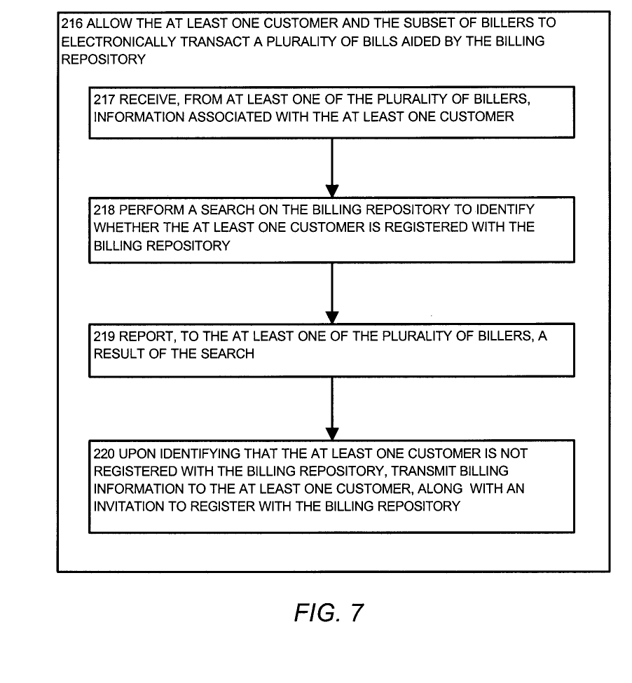

FIG. 7 is an embodiment of the steps performed by billing repository operating process 140-2 when it allows the customer 108-1 and the subset of billers 120-N to electronically transact a plurality of bills, aided by the billing repository 150.

In step 216, the billing repository operating process 140-2 allows the customer 108-1 and the subset of billers 120-N to electronically transact a plurality of bills, aided by the billing repository 150. The customers 108-N may find whether their billers 120-N are registered in the billing repository 150, and the plurality of billers 120-N may find whether their respective customers 108-N are registered in the billing repository 150.

In step 217, the billing repository operating process 140-2 receives, from at least one of the plurality of billers 120-N, information associated with at least one customer 108-1. In other words, a biller 120-1 transmits customer 108-1 information (such as the customer's 108-1 name and postal address) to the billing repository 150.

In step 218, the billing repository operating process 140-2 performs a search on the billing repository 150 to identify whether the customer 108-1 is registered with the billing repository 150. The billing repository operating process 140-2 performs a look up within the billing repository 150 to determine if the customer 108-1 is registered in the billing repository 150.

In step 219, the billing repository operating process 140-2 reports, to at least one of the plurality of billers 120-N, a result of the search. In other words, the billing repository operating process 140-2 informs the biller 120-1 whether the customer 108-1 is registered within the billing repository 150. If the customer 108-1 is registered within the billing repository 150, then the biller 120-1 (which is already registered within the billing repository 150) may begin to transact bills with the customer 108-1.

In step 220, upon identifying that at least one customer 108-1 is not registered with the billing repository 150, the billing repository operating process 140-2, transmits billing information to the customer 108-1, along with an invitation to register with the billing repository 150. In an example embodiment, upon discovering that the customer 108-1 is not registered with the billing repository 150, the billing repository operating process 140-2 transmits the billing information (i.e., a paper-based bill based on billing information provided by the biller 120-1) to the customer 108-1, along with an invitation to the customer 108-1 to register with the billing repository 150.

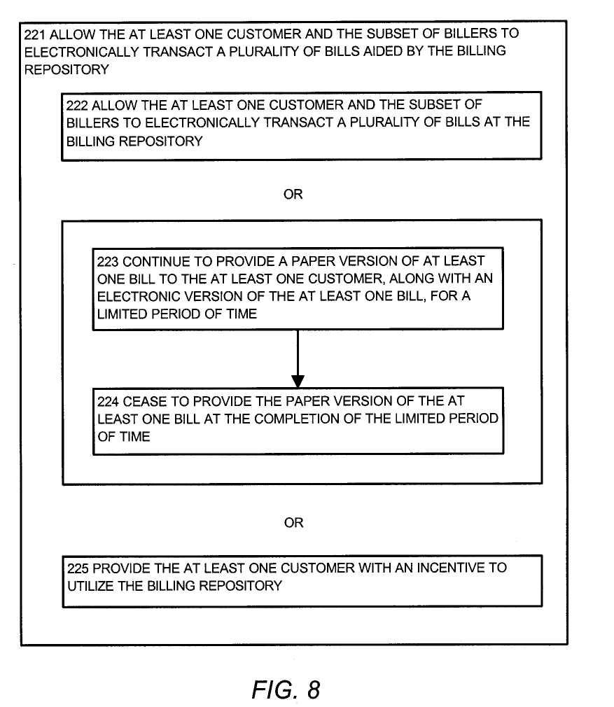

FIG. 8 is an embodiment of the steps performed by billing repository operating process 140-2 when it allows at least one customer 108-1 and the subset of billers 120-N to electronically transact a plurality of bills, aided by the billing repository 150.

In step 221, the billing repository operating process 140-2 allows at least one customer 108-1 and the subset of billers 120-N to electronically transact a plurality of bills, aided by the billing repository 150. The billing repository operating process 140-2 allows the customer 108-1 and the subset of billers 120-N to electronically transact a plurality of bills at a plurality of locations, such as the web site associated with a respective biller 120-1 or at a consolidator 125.

In step 222, the billing repository operating process 140-2 allows at least one customer 108-1 and the subset of billers 120-N to electronically transact (i.e., transmit bills, receive bills, pay bills, receive payments, etc.) a plurality of bills, at the billing repository 150.

Alternatively, in step 223, the billing repository operating process 140-2 continues to provide a paper-based version of at least one bill to the customer 108-1, along with an electronic version of the bill, for a limited period of time. For example, the billing repository operating process 140-2 may provide the customer 108-1 with an electronic version of the bill, and a paper-based bill for a period of three months after the customer 108-1 begins the process of electronic billing with the respective biller 120-1.

In step 224, the billing repository operating process 140-2 ceases to provide the paper version of the bill at the completion of the limited period of time. In other words, the billing repository operating process 140-2 may provide the customer 108-1 with a paper-based version of the bill, along with the electronic version of the bill, for a specified time, and then switch to providing only the electronic version of the bill once that specified time period expires.

Alternatively, in step 225, the billing repository operating process 140-2 provides the customer 108-1 with an incentive to utilize the billing repository 150. In an example embodiment, the billing repository operating process 140-2 provides a discount to the customer 108-1 to encourage the customer 108-1 to utilize the billing repository operating process 140-2. For example, the billing repository operating process 140-2 may provide the customer 108-1 with a small discount (towards paying a bill) when the customer 108-1 pays that bill electronically.

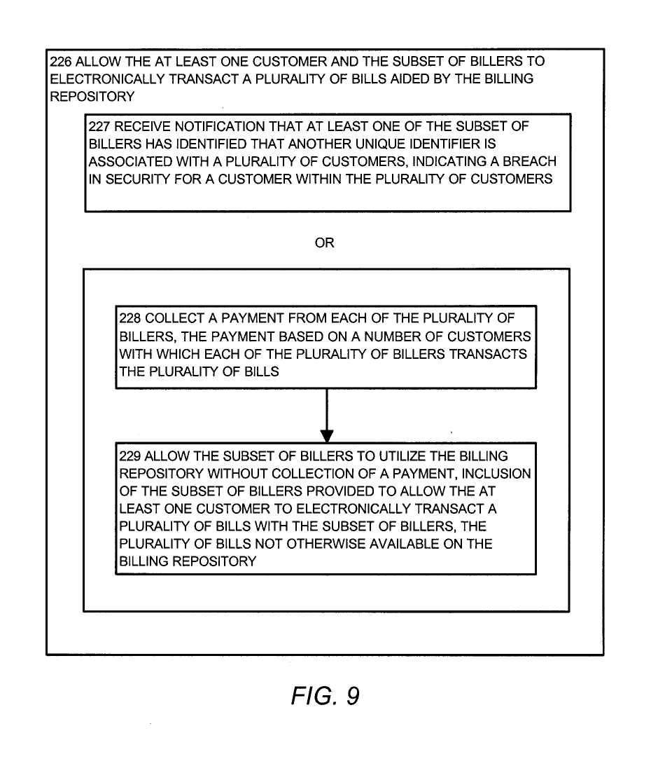

FIG. 9 is an embodiment of the steps performed by billing repository operating process 140-2 when it allows the customer 108-1 and the subset of billers 120-N to electronically transact a plurality of bills, aided by the billing repository 150.

In step 226, the billing repository operating process 140-2 allows the customer 108-1 and the subset of billers 120-N to electronically transact a plurality of bills, aided by the billing repository 150. In an example embodiment, having all the customer's 108-1 bills flow through a single billing repository 150 provides some security features not available when the customer 108-1 transacts bills from variety of methods.

In step 227, the billing repository operating process 140-2 receives notification that at least one of the subset of billers 120-N has identified that another unique identifier is associated with a plurality of customers 108-N, indicating a breach in security for a customer 108-1 within the plurality of customers 108-N. In other words, the billing repository operating process 140-2 may also discover identity theft by determining that another unique identifier (such as a social security number) is being used by multiple customers 108-N. For example, customers 108-N provide billers 120-N with customer information such as social security numbers. A biller 120-1 might compare social security numbers maintained within the billing repository 150 with social security numbers associated with that biller's 120-1 customers 108-N (meaning both customers 108-N who are registered with the billing repository 150, and those customers 108-N who are not registered with the billing repository 150). That comparison may identify duplicate social security numbers, even if one of the customers 108-N identified was not a registered user of the billing repository 150.

Alternatively, in step 228, the billing repository operating process 140-2 collects a payment from each of the plurality of billers 120-N. The payment is based on a number of customers 108-N with which each of the plurality of billers 120-N transacts the plurality of bills. The business model of the billing repository operating process 140-2 is based on a pay per customer 108-1 model for each biller 120-1 utilizing the billing repository 150. Each biller 120-1 pays a fee for each of that biller's 120-1 customers 108-N who utilize the billing repository 150.

In step 229, the billing repository operating process 140-2 allows the subset of billers 120-N to utilize the billing repository 150 without collection of a payment. Inclusion of the subset of billers 120-N is provided to allow the customer 108-1 to electronically transact a plurality of bills with the subset of billers 120-N (which are not otherwise available on the billing repository 150). In other words, large and medium billers 120-N are able to justify the cost of utilizing the billing repository 150. However, smaller billers 120-N, or occasional billers 120-N (such as law service providers, dentists, etc.) may not be able to justify the cost. The billing repository operating process 140-2 allows small and occasional billers 120-N to utilize the billing repository 150 so that the customers 108-N are able to receive all of their bills through the billing repository 150.

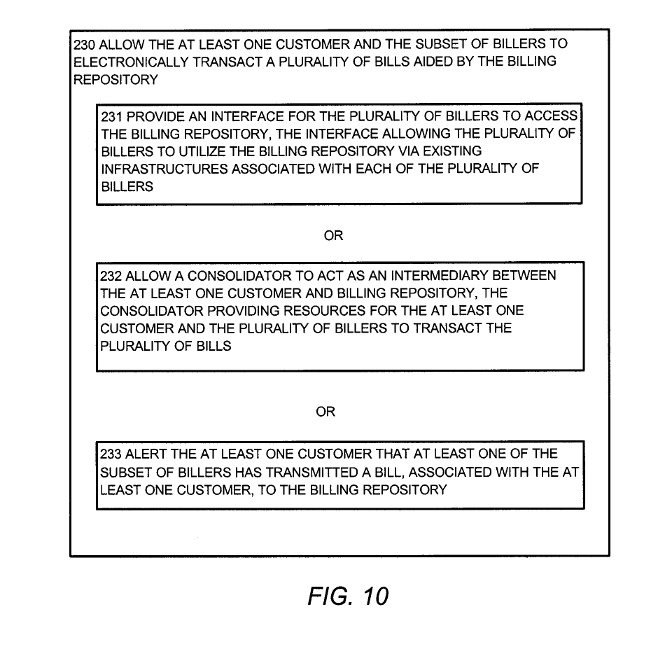

FIG. 10 is an embodiment of the steps performed by billing repository operating process 140-2 when it allows at least one customer 108-1 and the subset of billers 120-N to electronically transact a plurality of bills aided by the billing repository 150.

In step 230, the billing repository operating process 140-2 allows at least one customer 108-1 and the subset of billers 120-N to electronically transact a plurality of bills aided by the billing repository 150. The billing repository operating process 140-2 allows the customer 108-1 to transact bills with billers 120-N regardless of the size of the biller 120-1 or the capacity of the biller 120-1 to provide electronic billing.

In step 231, the billing repository operating process 140-2 provides an interface for the plurality of billers 120-N to access the billing repository 150. The interface allows the plurality of billers 120-N to utilize the billing repository 150 via existing infrastructures associated with each of the plurality of billers 120-N. In other words, a small biller 120-1 might not use a large billing provider to send out bills. The small biller 120-1 may print out bills from a personal computer, using a small business accounting software program. In an example embodiment, the billing repository operating process 140-2 provides that small biller 120-1 with an interface that allows the small biller 120-1 to access the billing repository 150 through the interface of the small business accounting software program. Thus, to the customer 108-1, the customer 108-1 is able to access all their bills regardless of the size of the biller 120-1 providing those bills.

Alternatively, in step 232, the billing repository operating process 140-2 allows a consolidator 125 to act as an intermediary between at least one customer 108-1 and the billing repository 150. The consolidator 125 provides resources for at least one customer 108-1 and the plurality of billers 120-N to transact the plurality of bills. In an example embodiment, a consolidator 125 might be a bank or a banking web site. The billing repository operating process 140-2 allows the consolidator 125 to offer consolidator subscribers to register with the billing repository 150 through the consolidator 125. The consolidator 125 is also able to inform the billing repository 150 of customer 108-1 postal address changes.

In step 233, the billing repository operating process 140-2 alerts the customer 108-1 that at least one of the subset of billers 120-N has transmitted a bill, associated with at least one customer 108-1, to the billing repository 150. In an example embodiment, the billing repository operating process 140-2 alerts the customer 108-1 when bills are ready to be paid or when payment has been made. In another example embodiment, the billing repository operating process 140-2 provides a consolidator 125 with the ability to provide this service to the subscribers (i.e., customers 108-N) of the consolidator 125.

While computer systems and methods have been particularly shown and described above with references to configurations thereof, it will be understood by those skilled in the art that various changes in form and details may be made therein without departing from the scope disclosed herein. Accordingly, the information disclosed herein is not intended to be limited by the example configurations provided above.

1. A computer-implemented method of operating a billing repository, the computer-implemented method comprising:
receiving, from at least one customer, customer registration input that registers the at least one customer with a billing repository being executed on a computerized device, the customer registration input including a customer postal address;
normalizing the postal address to a consistent postal address format referenced by the billing repository;
providing a unique identifier to the at least one customer, the unique identifier identifying the at least one customer within the billing repository based on customer name and normalized postal address;
receiving, from a plurality of billers, biller registration input that registers the plurality of billers with the billing repository;
receiving billing from at least one of the plurality of billers, the billing corresponding to the at least one customer;
associating, in the billing repository, the at least one customer with a subset of billers from the plurality of billers using the unique identifier, the subset of billers identifying the at least one customer by the unique identifier;
in response to receiving, via a graphical customer interface, transaction input from the at least one customer, executing electronic billing transactions of a plurality of bills using the billing repository;
in response to receiving, via a graphical biller interface, transaction input from the subset of billers executing electronic billing transactions of the plurality of bills using the billing repository; and
receiving notification that at least one of the subset of billers has identified that another unique identifier is associated with a plurality of customers, indicating a breach in security for a customer within the plurality of customers, the notification from a first biller of the subset of billers, wherein the notification is sent in response to the first biller detecting that the another unique identifier corresponds to both a first customer registered with the billing repository and a second customer not registered with the billing repository based on customer data maintained by the first biller, first customer data being maintained by the billing repository and second customer data being maintained separately from the billing repository by the first biller.

2. (canceled)

3. The computer-implemented method of claim 1 wherein receiving customer registration input that registers the at least one customer with the billing repository comprises:
providing, to the at least one customer, information associated with a plurality of registered billers, the plurality of registered billers identified as billers registered with the billing repository, repository, the registration of the at least one customer allowing the at least one customer access to a plurality of currently registered billers and a plurality of future registered billers.

4. The computer-implemented method of claim 1 wherein providing a unique identifier to the at least one customer, the unique identifier identifying the at least one customer within the billing repository comprises:
providing the at least one customer with a unique identifier not previously identified with the at least one customer.

5. The computer-implemented method of claim 1 wherein receiving, from a plurality of billers, biller registration input that registers the plurality of billers with the billing repository comprises:
upon successful completion of registration with the billing repository, receiving, from the plurality of billers, a transmission of a plurality of bills to the biller repository.

6. The computer-implemented method of claim 1 wherein receiving, from a plurality of billers, biller registration input that registers the plurality of billers with the billing repository comprises:
upon a single successful completion of registration with the billing repository, transmitting communications between the plurality of billers and a plurality of customers registered with the billing repository.

7. The computer-implemented method of claim 1, wherein receiving, from a plurality of billers, biller registration input that registers the plurality of billers with the billing repository comprises:
receiving, from at least one of the plurality of billers, information associated with the at least one customer;
performing a search on the billing repository that identifies whether the at least one customer is registered with the billing repository; and reporting, to the at least one of the plurality of billers, a result of the search.

8. The computer-implemented method of claim 7 further comprising:
upon identifying that the at least one customer is not registered with the billing repository, transmitting billing information to the at least one customer, along with an invitation to register with the billing repository.

9. The computer-implemented method of claim 1 wherein receiving, from a plurality of billers, biller registration input that registers the plurality of billers with the billing repository comprises:
receiving, from the plurality of billers, a choice of a method by which the billing is transmitted to the at least one customer, the choice including at least one of electronic billing and paper based billing.

10. (canceled)

11. The computer-implemented method of claim 1 wherein executing electronic billing transactions of a plurality of bills using the billing repository executing electronic billing transactions of a plurality of bills using the billing repository comprises:
continuing to provide a paper version of at least one bill to the at least one customer, along with an electronic version of the at least one bill, for a limited period of time; and
ceasing to provide the paper version of the at least one bill at the completion of the limited period of time.

12. The computer-implemented method of claim 1 wherein executing electronic billing transactions of a plurality of bills using the billing repository comprises:
providing the at least one customer with an incentive to utilize the billing repository.

13. (canceled)

14. The computer-implemented method of claim 1 wherein allowing the at least one customer and the subset of billers to electronically transact a plurality of bills aided by the billing repository comprises:
collecting a payment from each of the plurality of billers, the payment based on a number of customers with which each of the plurality of billers transacts the plurality of bills.

15. (canceled)

16. The computer-implemented method of claim 1 wherein executing electronic billing transactions of a plurality of bills using the billing repository comprises:
providing an interface for the plurality of billers to access the billing repository, receiving input, via the interface and from the plurality of billers, that utilizes the billing repository via existing infrastructures associated with each of the plurality of billers.

17. The computer-implemented method of claim 1 wherein allowing the at least one customer and the subset of billers to electronically transact a plurality of bills aided by the billing repository comprises:
allowing a consolidator to act as an intermediary between the at least one customer and billing repository, the consolidator providing resources for the at least one customer and the plurality of billers to transact the plurality of bills, the consolidator being a bank.

18. The computer-implemented method of claim 1 wherein executing electronic billing transactions of a plurality of bills using the billing repository comprises:
alerting the at least one customer that at least one of the subset of billers has transmitted a bill, associated with the at least one customer, to the billing repository.

19. A computerized device comprising:
a memory;
a processor;
a communications interface;
an interconnection mechanism coupling the memory, the processor and the communications interface;
wherein the memory is encoded with billing repository operating application that when executed on the processor is capable of operating a billing repository on the computerized device by performing the operations of:
receiving from at least one customer, customer registration input that registers the at least one customer with a billing repository being executed on a computerized device, the customer registration input including a customer postal address;
normalizing the postal address to a consistent postal address format referenced by the billing repository;
providing a unique identifier to the at least one customer, the unique identifier identifying the at least one customer within the billing repository based on customer name and normalized postal address;
receiving, from a plurality of billers, biller registration input that registers the plurality of billers with the billing repository;
receiving billing from at least one of the plurality of billers, the billing corresponding to the at least one customer;
associating, in the billing repository, the at least one customer with a subset of billers from the plurality of billers using the unique identifier, the subset of billers identifying the at least one customer by the unique identifier;
in response to receiving, via a graphical customer interface, transaction input from the at least one customer, executing electronic billing transactions of a plurality of bills using the billing repository;
in response to receiving, via a graphical biller interface, transaction input from the subset of billers, executing electronic billing transactions of the plurality of bills using the billing repository; and
receiving notification that at least one of the subset of billers has identified that another unique identifier is associated with a plurality of customers, indicating a breach in security for a customer within the plurality of customers, the notification from a first biller of the subset of billers, wherein the notification is sent in response to the first biller detecting that the another unique identifier corresponds to both a first customer registered with the billing repository and a second customer not registered with the billing repository based on customer data maintained by the first biller, first customer data being maintained by the billing repository and second customer data being maintained separately from the billing repository by the first biller.

20. A non-transitory computer readable storage medium having computer readable code thereon, the medium comprising:
instructions for receiving, from at least one customer, customer registration input that registers the at least one customer with a billing repository being executed on a computerized device, the customer registration input including a customer postal address;
instructions for normalizing the postal address to a consistent postal address format referenced by the billing repository;
instructions for providing a unique identifier to the at least one customer, the unique identifier identifying the at least one customer within the billing repository based on customer name and normalized postal address;
instructions for receiving, from a plurality of billers, biller registration input that registers the plurality of billers with the billing repository;
receiving billing from at least one of the plurality of billers, the billing corresponding to the at least one customer;
instructions for associating, in the billing repository, the at least one customer with a subset of billers from the plurality of billers using the unique identifier, the subset of billers identifying the at least one customer by the unique identifier;
instructions for in response to receiving, via a graphical customer interface, transaction input from the at least one customer, executing electronic billing transactions of a plurality of bills using the billing repository;
in response to receiving, via a graphical biller interface, transaction input from the subset of billers, executing electronic billing transactions of the plurality of bills using the billing repository; and
instructions for receiving notification that at least one of the subset of billers has identified that another unique identifier is associated with a plurality of customers, indicating a breach in security for a customer within the plurality of customers, the notification from a first biller of the subset of billers, wherein the notification is sent in response to the first biller detecting that the another unique identifier corresponds to both a first customer registered with the billing repository and a second customer not registered with the billing repository based on customer data maintained by the first biller, first customer data being maintained by the billing repository and second customer data being maintained separately from the billing repository by the first biller.

21. The method of claim 1, further comprising:
identifying that the at least one customer is a customer of a second biller based on address records of the second biller; and
electronically transmitting a corresponding bill to the at least one customer in lieu of mailing the corresponding bill to a postal address of the at least one customer.
